(19) United States
(12) Patent Application Publication
(10) Pub. No.: US 2006/0055454 A1
(43) Pub. Date: Mar. 16, 2006

(54) Dynamic transconductance boosting technique for current mirrors

(75) Inventor: Matthias Eberlein, Gilching (DE)

Correspondence Address: STEPHEN B. ACKERMAN, 28 DAVIS AVENUE, POUGHKEEPSIE, NY, 12603, US

(73) Assignee: Dialog Semiconductor Gmbh

(21) Appl. No.: 10/948,007

(22) Filed: Sep. 23, 2004

(30) Foreign Application Priority Data
Sep. 14, 2004 (EP) 04368064.4

(51) Int. Cl. G05F 1/10

(52) U.S. Cl. 327/538

(57) ABSTRACT

Circuits and methods to increase the transconductance of a current mirror in case of small input currents of the current mirror without affecting the transconductance of said current mirror in case of large input currents have been achieved. Key of the invention is a “bypass” formed by a transistor in series with a resistor, wherein the bypass is in parallel to the input transistor of the current mirror. This bypass is only relevant for very small input currents wherein the resistor can be neglected compared to the impedance of the bypass-transistor and therefore the total transconductance of the current mirror is increased in case of very small input currents. For large input currents the resistor of the bypass effectively blocks the “bypass” path. The invention solves e.g. a problem of amplifiers having any kind of dynamic biasing namely that the input impedance of current mirrors becomes too large for very small input currents.

This application is related to U.S. patent application docket number DS04-034, U.S. Ser. No. ______ filed: ______ and assigned to the same assignee as the present invention.

### BACKGROUND OF THE INVENTION

(1) Field of the Invention

This invention relates generally to current mirrors, and more particularly to a current mirror with increased transconductance at low biasing currents.

(2) Description of the Prior Art

Amplifiers with any kind of dynamic biasing face the problem that the input impedance of current mirrors gets to large for very small biasing currents, causing stability problems due to parasitic poles, Currently low current biasing is either not possible or compromises have to be made towards accuracy or power consumption.

Especially MOS current mirrors with large mirror ratios 1:N (e.g. N>100) suffer from large parasitic capacitance caused by the MOS gate. In case such a current mirror is used e.g. in an amplifier employing dynamic biasing, like the output stage of a “current mode LDO”, as described in the U.S. patent application U.S. patent application docket number DS04-034, U.S. Ser. No. ______ filed: ______ the input impedance (1/gm) becomes extremely large for very small currents (e.g. <200 nA). This results in a low frequency pole of the (small signal) current transfer function, which can cause stability problems. Previous solutions have either avoided such low currents or large mirror ratios (both increase power consumption), or used a resistor in parallel to the mirror input. This resistor affects negatively accuracy at medium and low currents in an unpredictable way due to process variations and also increases quiescent current.

There are various patents describing the usage of current mirrors in amplifiers or LDOs.

U.S. Pat. No. (6,710,583 to Stanescu et al.) describes a low dropout voltage regulator circuit with non-Miller frequency compensation. The circuit includes an input voltage terminal; an output voltage terminal; an error amplifier having a first input coupled to a reference voltage; a voltage follower coupled to an output of the error amplifier; a pass device; and a feedback network. An input terminal of the pass device is coupled to the input voltage terminal. A control terminal of the pass device is coupled to an output of the voltage follower. An output terminal of the pass device is the output voltage terminal. The feedback network includes two resistors in series between the output voltage terminal and ground. A node between the resistors is coupled to a second input of the error amplifier. A frequency compensation capacitor also is coupled between the output voltage terminal and the node. The output stage comprises a pair of NMOS transistors cascoded by another pair of NMOS transistors, driving current mirror PMOS transistors.

U.S. Pat. No. (5,889,393 to Wrathall) discloses a voltage regulator and method of voltage regulation utilizing an error amplifier and a transconductance amplifier together with a voltage reference, startup circuit and output load. The use of the transconductance amplifier allows the use of an arrangement of two poles and a zero such that the composite gain roll-off has a generally constant slope. One of the poles utilized in this stability scheme is the outer pole formed by the resistive-like load and its filter capacitor. Another pole and zero are generated in the error amplifier circuit. To decouple the noisy input supply voltage, sensitive parts of the circuit are powered by the regulated output voltage. A start circuit is provided to start up the output and voltage reference when no output voltage is present. The transconductance amplifier block has special characteristics, which allow it to work to relatively high frequency, above the gain bandwidth product of the control loop. It is driven by a fully differential push-pull, class AB amplifier. The transconductance amplifier utilizes a current mirror approach to current sensing in the output device, which utilizes cascode techniques for more accurate current sensing in the current mirror.

U.S. Pat. No. (6,518,737 to Brokaw) discloses a single-loop voltage regulator controller including a high-gain transconductance amplifier that accommodates common mode inputs as low as its negative supply rail. The input stage of the amplifier produces a proportional to absolute temperature (PTAT) input offset voltage. The transconductance amplifier's inverting input is connected to the circuit common, or negative supply rail, and a tap from a feedback network is connected to the amplifier's no inverting input. The feedback network provides, at this tap, a PTAT measure of the regulator's regulated output. The amplifier's output is connected to drive a no inverting driver, which, in turn, is connected to drive the control terminal of the regulator's pass transistor. A compensation capacitor connected between the amplifier's output and the regulated output terminal ensures the regulator's stability even for relatively low level load impedances The voltage regulator further comprises a bias circuit connected to provide bias current to a current mirror, and a differential to single-ended converter connected to convert an amplified differential signal from said differential pair into a single-ended signal and to modulate the bias current in response to variations in said amplified differential signal.

### SUMMARY OF THE INVENTION

A principal object of the present invention is to achieve a current mirror having increased transconductance at low input currents only.

Another principal object of the present invention is to achieve a method for current mirrors having increased transconductance at low input currents only.

In accordance with the objects of this invention a circuit to increase the transconductance of a current mirror in case of small input currents of the current mirror without affecting the transconductance of said current mirror in case of large input currents has been achieved. This circuit comprises, first, a PMOS current mirror comprising an input transistor and an output transistor, wherein the sources of said both transistors are connected to VDD voltage, the drain of the output transistor is connected to the output of the current mirror, the gates of said both transistors are interconnected, and the gate and the drain of said input transistor are interconnected. Furthermore the circuit invented comprises a bypass of the input transistor of the current mirror. This bypass comprises a resistor and a PMOS transistor, wherein one terminal of said resistor is connected to VDD voltage, the other terminal of the resistor is connected to the source of said PMOS transistor, the gate of said PMOS transistor is connected to the drain of said PMOS transistor and to the drain of said input transistor of said current mirror.

In accordance with the objects of this invention another circuit to increase the transconductance of a current mirror in case of small input currents of the current mirror without affecting the transconductance of said current mirror in case of large input currents has been achieved. This circuit comprises, first, an NMOS current mirror comprising an input transistor and an output transistor, wherein the sources of said both transistors are connected to VSS voltage, the drain of the input transistor is connected to the input of the current mirror, the drain of the output transistor is connected to the output of the current mirror, the gates of said both transistors are interconnected, and the gate and the drain of said input transistor are interconnected. Furthermore this circuit comprises a bypass of said input transistor of said current mirror comprising a resistor and a NMOS transistor, wherein one terminal of said resistor is connected to VSS voltage, the other terminal of the resistor is connected to the source of said NMOS transistor, the gate of said NMOS transistor is connected to the drain of said NMOS transistor and to the drain of said input transistor of said current mirror.

In accordance with the objects of this invention a method to increase the transconductance of a current mirror in case of small input currents of the current mirror without affecting the transconductance of said current mirror in case of large input currents has been achieved. This method comprises, first, the provision of a current mirror comprising an input and an output transistor and a bypass in parallel to said input transistor. The next steps of the method are to ensure, in case of small input currents of said current mirror, that the input transconductance of the current mirror is increased by the transconductance of said bypass, and to ensure, in case of large input currents of said current mirror, that the input transconductance of the current mirror is not impacted by the bypass.

### BRIEF DESCRIPTION OF THE DRAWINGS

In the accompanying drawings forming a material part of this description, there is shown:

FIG. 1 shows a diagram of an embodiment of the circuit invented using PMOS transistors.

FIG. 2 illustrates a diagram of an embodiment of the circuit invented using NMOS transistors.

FIG. 3 shows a flowchart of the method invented to increase the transconductance of a current mirror in case of small input currents.

### DESCRIPTION OF THE PREFERRED EMBODIMENTS

The preferred embodiments of the present invention disclose novel circuits and methods for current mirrors having an increased transconductance with small currents without affecting the behavior for large currents.

FIG. 1 shows a schematic of the circuit of the present invention comprising a current mirror 1 comprising a PMOS input transistor M₀ and a PMOS output transistor M₁. Additionally a “bypass” PMOS transistor M₂ is hooked up in parallel to the input transistor M₀ of the current mirror 1 wherein the source of M₂ is connected to V_{DD} voltage via a resistor R₂, its gate is connected to its drain, to the drain of transistor M₀ and to the gates of transistors M₀ and M₁.

The output current I_{OUT} of the current mirror is flowing through transistor M₁. The input current I₁ is flowing through transistors M₀ and the bypass transistor M₂. A “bypass” current I₂ is flowing through the “bypass” transistor M₂. Preferably transistor M₂ matches in regard of the channel length with transistor M₀ but the width of transistor M₂ is much larger than the width of transistor M₀. As a non-limiting example only, resistor R₂ has 50 KOhm and
W(M₂)=6×W(M₀),
wherein W(M₂) is the width of transistor M₂ and W(M₀) is the width of transistor M₀.

For large input currents I₁ resistor R₂ effectively blocks the “bypass” path through transistor M₂. Since the input impedance (1/gm0) of transistor M₀ is smaller than the resistance of resistor R₂, the “bypass” current I₂ or in other words the error current I₂ becomes negligible small.

Otherwise, in case of very small input currents I₁, resistor R₂ becomes negligible small compared to the impedance (1/gm2) of transistor M₂. Therefore the total input transconductance gm of the current mirror of the present invention is effectively increased to:
gm=gm0+gm2, (1)
wherein gm0 is the transconductance of transistor M₀ and gm2 is the transconductance of transistor M₂. This results in an improved frequency transfer function. The parasitic pole can be calculated by

$$f = \frac{gm}{2 \cdot π \cdot {C}_{1}}$$

wherein gm=gm0+gm2, according to equation (1), and C₁ is the parasitic capacitance of the current mirror gates. The transconductance of the output transistor M₁ is not relevant for the transconductance of the current mirror.

Key of the invention is the “bypass” formed by transistor M₂ in series with resistor R₂. This bypass is only relevant for very small input currents wherein resistor R₂ can be neglected compared to the impedance of transistor M₂ and therefore the total transconductance of the current mirror is increased in case of very small input currents.

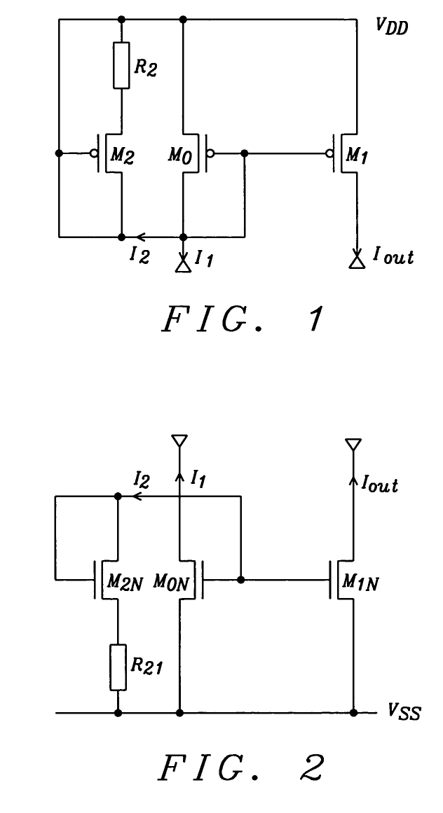

FIG. 2 shows an embodiment of the present invention using NMOS Transistors instead of PMOS transistors as shown in FIG. 1. The same principles as outlined above with PMOS transistors can be applied equivalently using NMOS transistors. Using NMOS transistors the sources of transistors M_{0N}, M_{1N} and M_{2N} are connected to V_{SS} voltage. The source of transistor M_{2N} is connected via resistor R₂ to V_{SS} voltage, the sources of transistors M_{0N} and M_{1N} are directly connected to V_{SS} voltage.

In both PMOS and NMOS embodiments of the present invention the “bypass” current is exactly predictable if the transconductance of the bypass transistor M₂ or M_{2N} matches the transconductance of the input transistor M₀ or respectively M_{0N} of the current mirror. The circuit invented improves the small signal behavior significantly without degrading large signal performance.

Additionally pnp or npn bipolar transistors can be used for an implementation of the present invention. The same principles as outlined above can be applied for bipolar transistors as well.

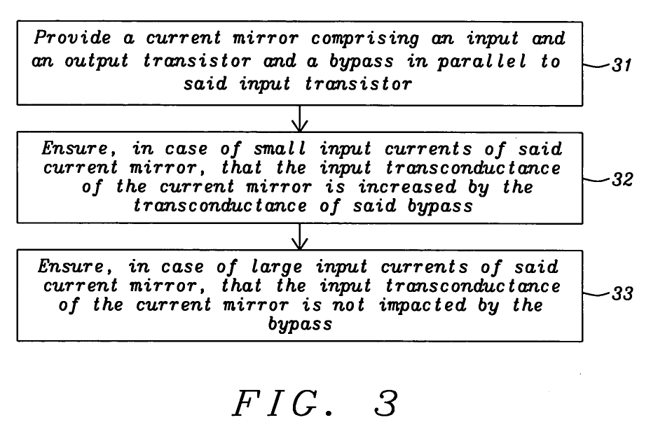

The flowchart of FIG. 3 illustrates a method to increase the transconductance of a current mirror in case of small input currents of the current mirror without affecting the transconductance in case of large input currents. The first step 31 describes the provision of a current mirror comprising an input and an output transistor and a bypass in parallel to said input transistor as described above. The second step 32 shows that it has to be ensured that, in case of small input currents of said current mirror, the input transconductance of the current mirror is increased by the transconductance of said bypass The next step 33 illustrates that it has to be ensured that, in case of large input currents of said current mirror, the input transconductance of the current mirror is not impacted by the bypass.

In a preferred embodiment of the invented method said bypass comprises a transistor, having a larger size than the input transistor of the current mirror, and a resistor as it has been described above. For small input currents of the current mirror this resistor becomes negligible compared to the input impedance of the transistor implemented in the bypass. For large input currents this resistor blocks the path through the bypass.

The circuits and methods invented can be e.g. applied with amplifiers having any kind of dynamic biasing. In prior art they have faced the problem of a too large input impedance of current mirrors in case of very small input currents. The invention provides a very effective solution to this problem.

While the invention has been particularly shown and described with reference to the preferred embodiments thereof, it will be understood by those skilled in the art that various changes in form and details may be made without departing from the spirit and scope of the invention.

What is claimed is:

1. A circuit to increase the transconductance of a current mirror in case of small input currents of the current mirror without affecting the transconductance of said current mirror in case of large input currents is comprising:
a PMOS current mirror comprising an input transistor and an output transistor, wherein the sources of said both transistors are connected to VDD voltage, the drain of the input transistor is connected to the input of the current mirror, the drain of the output transistor is connected to the output of the current mirror, the gates of said both transistors are interconnected, and the gate and the drain of said input transistor are interconnected; and
a bypass of said input transistor of said current mirror comprising a resistor and a PMOS transistor, wherein one terminal of said resistor is connected to VDD voltage, the other terminal of the resistor is connected to the source of said PMOS transistor, the gate of said PMOS transistor is connected to the drain of said PMOS transistor and to the drain of said input transistor of said current mirror.

2. The circuit of claim 1 wherein the size of said PMOS transistor of said bypass is much larger than the size of said input transistor of said current mirror.

3. The circuit of claim 2 wherein the width of said PMOS transistor of said bypass is six-times larger that the width of said input transistor of said current mirror.

4. The circuit of claim 1 wherein said resistor has a resistance in the order of magnitude of 50 KOhm.

5. The circuit of claim 1 wherein the transconductance of said bypass transistor matches the transconductance of said input transistor of said current mirror.

6. A circuit to increase the transconductance of a current mirror in case of small input currents of the current mirror without affecting the transconductance of said current mirror in case of large input currents is comprising:
an NMOS current mirror comprising an input transistor and an output transistor, wherein the sources of said both transistors are connected to VSS voltage, the drain of the input transistor is connected to the input of the current mirror, the drain of the output transistor is connected to the output of the current mirror, the gates of said both transistors are interconnected, and the gate and the drain of said input transistor are interconnected; and
a bypass of said input transistor of said current mirror comprising a resistor and a NMOS transistor, wherein one terminal of said resistor is connected to VSS voltage, the other terminal of the resistor is connected to the source of said NMOS transistor, the gate of said NMOS transistor is connected to the drain of said NMOS transistor and to the drain of said input transistor of said current mirror.

7. The circuit of claim 6 wherein the size of said NMOS transistor of said bypass is much larger than the size of said input transistor of said current mirror.

8. The circuit of claim 7 wherein the width of said NMOS transistor of said bypass is six-times larger that the width of said input transistor of said current mirror.

9. The circuit of claim 6 wherein said resistor has a resistance in the order of magnitude of 50 KOhm.

10. The circuit of claim 6 wherein the transconductance of said bypass transistor matches the transconductance of said input transistor of said current mirror.

11. A method to increase the transconductance of a current mirror in case of small input currents of the current mirror without affecting the transconductance of said current mirror in case of large input currents is comprising:
provide a current mirror comprising an input and an output transistor and a bypass in parallel to said input transistor;
ensure, in case of small input currents of said current mirror, that the input transconductance of the current mirror is increased by the transconductance of said bypass; and
ensure, in case of large input currents of said current mirror, that the input transconductance of the current mirror is not impacted by the bypass.

12. The method of claim 11 wherein said bypass comprises a transistor in series with a resistor.

13. The method of claim 12 wherein said transistor of said bypass and the transistors of said current mirror are PMOS transistors.

14. The method of claim 13 wherein said PMOS transistor of said bypass is significantly larger than said input transistor of said current mirror.

15. The method of claim 13 wherein the transconductance of said PMOS transistor of said bypass matches the transconductance of said input transistor of said current mirror

16. The method of claim 13 wherein said transistor of said bypass and the transistors of said current mirror are NMOS transistors.

17. The method of claim 16 wherein said NMOS transistor of said bypass is significantly larger than said input transistor of said current mirror.

18. The method of claim 16 wherein the transconductance of said NMOS transistor of said bypass matches the transconductance of said input transistor of said current mirror.

19. The method of claim 13 wherein said transistor of said bypass and the transistors of said current mirror are pnp bipolar transistors.

20. The method of claim 19 wherein said pnp bipolar transistor of said bypass is significantly larger than said input transistor of said current mirror.

21. The method of claim 19 wherein the transconductance of said pnp bipolar transistor of said bypass matches the transconductance of said input transistor of said current mirror.

22. The method of claim 13 wherein said transistor of said bypass and the transistors of said current mirror are npn bipolar transistors.

23. The method of claim 22 wherein said npn bipolar transistor of said bypass is significantly larger than said input transistor of said current mirror.

24. The method of claim 23 wherein the transconductance of said NMOS transistor of said bypass matches the transconductance of said input transistor of said current mirror
